(19) United States
(12) Patent Application Publication
(10) Pub. No.: US 2021/0134495 A1
(43) Pub. Date: May 6, 2021

(54) STINGER HOLDER

(71) Applicant: Billy Sensat, Bronson, TX (US)

(72) Inventor: Billy Sensat, Bronson, TX (US)

(21) Appl. No.: 16/669,404

(22) Filed: Oct. 30, 2019

(51) Int. Cl. H01B 17/42

(52) U.S. Cl. CPC H01B 17/42

(57) ABSTRACT

An illustrated view of an exemplary stinger holder for preventing electric arcing from harming equipment, property and people is presented. The stinger holder is useful for keeping people and objects out of harm's way when by preventing kick around and letting an arc couple to the equipment and ruin the equipment, people and other property. Also, the stinger holder is useful for grinder equipment by holding pipes from falling into water at a bottom of a ditch. The stinger holder prevent electrical DC shock and thereby providing longevity to the equipment and provide a guard for the people.

### FIELD OF THE INVENTION

This invention relates to electric arcings. More particularly, it relates to a device for preventing being shocked by a stinger from an electric arcing.

### BACKGROUND

Electricity is the set of physical phenomena associated with the presence and motion of matter that has a property of electric charge. In early days, electricity was considered as being unrelated to magnetism. Later on, many experimental results and the development of Maxwell's equations indicated that both electricity and magnetism are from a single phenomenon: electromagnetism. Various common phenomena are related to electricity, including lightning, static electricity, electric heating, electric discharges and many others.

An electric arc, or arc discharge, is an electrical breakdown of a gas that produces a prolonged electrical discharge. The current through a normally nonconductive medium such as air produces a plasma; the plasma may produce visible light. An arc discharge is characterized by a lower voltage than a glow discharge and relies on thermionic emission of electrons from the electrodes supporting the arc. An archaic term is voltaic arc, as used in the phrase “voltaic arc lamp”.

Techniques for arc suppression can be used to reduce the duration or likelihood of arc formation.

In the late 1800s, electric arc lighting was in wide use for public lighting. Some low-pressure electric arcs are used in many applications. For example, fluorescent tubes, mercury, sodium, and metal-halide lamps are used for lighting; xenon arc lamps have been used for movie projectors.

Undesired or unintended electric arcing can have detrimental effects on electric power transmission, distribution systems and electronic equipment. Devices which may cause arcing include switches, circuit breakers, relay contacts, fuses and poor cable terminations. When an inductive circuit is switched off, the current cannot instantaneously jump to zero: a transient arc will be formed across the separating contacts. Switching devices susceptible to arcing are normally designed to contain and extinguish an arc, and snubber circuits can supply a path for transient currents, preventing arcing. If a circuit has enough current and voltage to sustain an arc formed outside of a switching device, the arc can cause damage to equipment such as melting of conductors, destruction of insulation, and fire. An arc flash describes an explosive electrical event that presents a hazard to people and equipment.

Arcing can also occur when a low resistance channel (foreign object, conductive dust, moisture . . . ) forms between places with different voltage. The conductive channel then can facilitate formation of an electric arc. The ionized air has high electrical conductivity approaching that of metals, and it can conduct extremely high currents, causing a short circuit and tripping protective devices (fuses and circuit breakers). A similar situation may occur when a lightbulb burns out and the fragments of the filament pull an electric arc between the leads inside the bulb, leading to overcurrent that trips the breakers.

An electric arc over the surface of plastics causes their degradation. A conductive carbon-rich track tends to form in the arc path, called “carbon tracking”, negatively influencing their insulation properties. The arc susceptibility, or “track resistance”, is tested according to ASTM D495, by point electrodes and continuous and intermittent arcs; it is measured in seconds required to form a track that is conductive under high-voltage low-current conditions. Some materials are less susceptible to degradation than others. For example, polytetrafluoroethylene has arc resistance of about 200 seconds (3.3 minutes). From thermosetting plastics, alkyds and melamine resins are better than phenolic resins. Polyethylene's have arc resistance of about 150 seconds; polystyrenes and polyvinyl chlorides have relatively low resistance of about 70 seconds. Plastics can be formulated to emit gases with arc-extinguishing properties; these are known as arc-extinguishing plastics.

Arcing over some types of printed circuit boards, possibly due to cracks of the traces or the failure of a solder, renders the affected insulating layer conductive as the dielectric is combusted due to the high temperatures involved. This conductivity prolongs the arcing due to cascading failure of the surface.

In light of the foregoing, it would be desirable to devise a device that may reduce the chance for an electric arcing from occurring, thus protecting equipment, buildings and people.

### BRIEF DESCRIPTION OF THE DRAWINGS

FIG. 1A is an illustrated view of an exemplary stinger holder.

FIG. 1B is an illustrated side view of the stinger holder shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

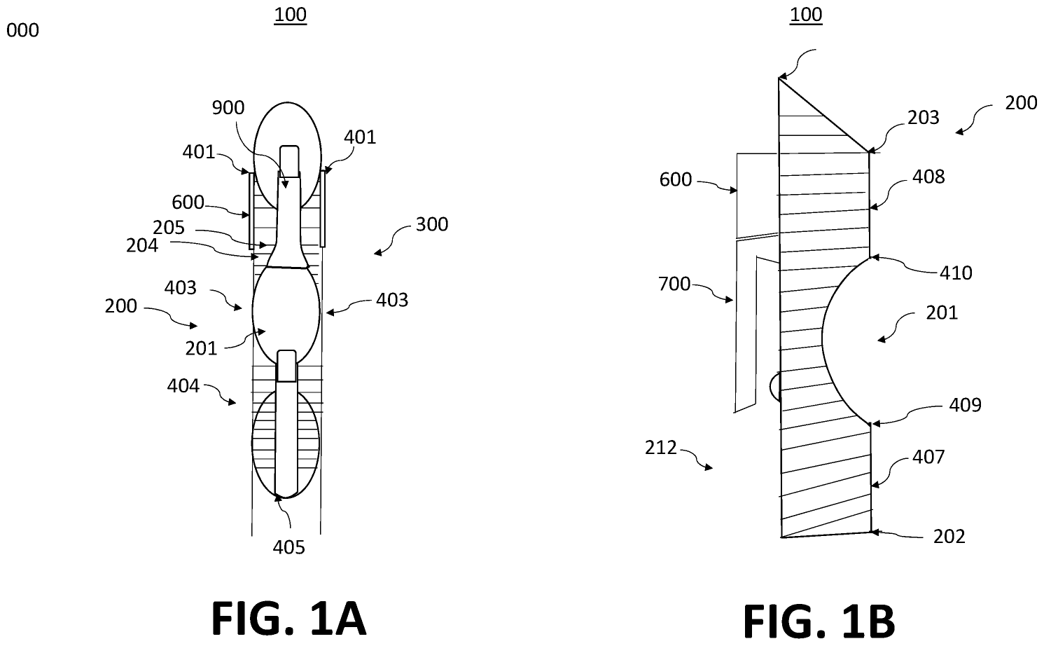

Referring to FIG. 1A and FIG. 1B, an illustrated view of an exemplary stinger holder 100 for preventing electric arcing from harming equipment, property and people is presented. The stinger holder 100 is useful for keeping people and objects out of harm's way when by preventing kick around and letting an arc couple to the equipment and ruin the equipment, people and other property. Also, the stinger holder 100 is useful for grinder equipment by holding the stinger from falling into water at a bottom of a ditch. The stinger holder 100 prevent electrical DC shock and thereby providing longevity to the equipment and provide a guard for the people.

The stinger holder 100 preferably has a height of nine and one-half (9.5) inches, however other heights are hereby contemplated, including, but not limited to, eight (8) inches, ten (10) inches, etc. The stinger holder 100 preferably has a length of one and one-half (1.5) inches, however other lengths are hereby contemplated, including, but not limited to, one (1) inch, three (3) inches, etc. The stinger holder 100 preferably has a width of one (1) inch, however other widths are hereby contemplated, including, but not limited to, one-half (0.5) inch, two (2) inches, etc. The stinger holder 100 is preferably adjustable in length. The stinger holder 100 is preferably made of a rubber material, however other materials are hereby contemplated, including, but not limited to, poly-vinyl chloride (PVC), cork, etc.

The stinger holder 100 has a first arm 200 and a second arm 300. The first arm 200 and the second arm 300 are identical and will be described in a single description which shall apply to both the first arm 200 and the second arm 300. The first arm 200 is coupled to the second arm 300 whereby a gap 900 is created. The gap 900 is preferably has a length of one (1) inch.

The first arm 200 has a top 401, a bottom 402, a middle portion 403, a first side 404 and a second side 405. The first side 404 preferably has a height of nine and one-half (9.5) inches, however other heights are hereby contemplated, including, but not limited to, eight (8) inches, ten (10) inches, etc. The first side 100 preferably has a length of one-half (0.5) inch, however other lengths are hereby contemplated, including, but not limited to, one-fourth (0.25) inch, three-fourths (0.75) inch, etc.

The first arm 200 has an indentation 201 configured significantly near a middle 406 of the second side 405. The indentation 201 preferably has a height of two and one-half (2.5) inches. The indentation 201 preferably has a length of one-fourth (0.25) inch. The second side 405 further has a first segment 407 and a second segment 408. The first segment 407 is configured between a bottom 202 of the first arm 200 and a bottom end 409 of the indentation 201. The second segment 408 is configured between a top 203 of the second side 405 and a top 410 of the indentation 201. The second segment 405 preferably has a height being one and one-half (1.5) inches. The first segment 404 preferably has a height of four (4) inches.

A face 204 of the first arm 200 has a plurality of perforations 205. The perforations 205 are guides to trim the first arm 200 depending on whether a rod in a stinger is left attached.

In FIG. 1B, an illustrated side view of the stinger holder 100 shown in FIG. 1A is presented.

The first arm 200 has a back side 212. The back side 404 has a pocket clip 500 and a magnet 600. The magnet 600 is useful for coupling to the equipment. The magnet 600 is preferably configured to be one and one-half (1.5) inches from a top 601 of the first arm 200.

The pocket clip 500 is preferably an “L” shape clip, the pocket clip 500 providing a transportable stinger holder 100 by clipping onto a pocket of a person. The pocket clip 500 is coupled to the back side 212 of the first arm 200. The pocket clip 500 preferably has a length of four (4) inches.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A stinger holder for preventing electrical arcing from a stinger, the holder comprising:
a first arm and a second arm, the first arm being coupled to the second arm wherein a gap being configured;
the first arm having a first side, a second side, a back, a face, a top and a bottom;
the second arm having a first side, a second side, a back, a face, a top and a bottom;
the second side of the first arm has an indentation configured substantially near a middle of the second side of the first arm;
the second side of the second arm has an indentation configured substantially near a meddle of the second side;
the second side of the first arm further having a first segment and a second segment;
the first side of the second arm further having a first segment and a second segment; and
a magnet, the magnet being coupled to the back of the first arm, and wherein the magnet being coupled to the back of the second arm; and
a pocket clip, the pocket clip being coupled to the back of the first arm, and wherein the pocket clip being coupled to the back of the second arm.

2. The holder of claim 1, wherein the face of the first arm having perforations.

3. The holder of claim 2, wherein the perforations being configured to adjust the length of the first arm.

4. The holder of claim 1, wherein the face of the first arm having perforations.

5. The holder of claim 5, wherein the perforations being configured to adjust the length of the second arm.

6. The holder of claim 1, wherein the holder having a length being one and one-half (1.5) inches.

7. The holder of claim 1, wherein the holder having a height being nine and one-half (9.5) inches.

8. The holder of claim 1, wherein the holder having a width being one and one-half (1.5) inches.

9. The holder of claim 1, wherein the gap having a length being one (1) inch.

10. The holder of claim 1, wherein the indentation of the first arm having a height being two and one-half (2.5) inches.

11. The holder of claim 1, wherein the indentation of the first arm having a length being four (4) inches.

12. The holder of claim 1, wherein the indentation of the second arm having a height being two and one-half (2.5) inches.

13. The holder of claim 1, wherein the indentation of the second arm having a length being four (4) inches.

14. The holder of claim 1, wherein the first segment of the second side of the first arm having a height being two and one-half (2.5) inches.

15. The holder of claim 1, wherein the magnet being configured to be one and one-half (1.5) inches from the top of the first arm.

16. The holder of claim 1, wherein the magnet being configured to be one and one-half (1.5) inches from the top of the second arm.

17. The holder of claim 1, wherein the pocket clip having a length being four (4) inches.

18. The holder of claim 1, wherein the pocket clip being an “L” shape.
